(19) United States
(12) Patent Application Publication
(10) Pub. No.: US 2015/0119182 A1
(43) Pub. Date: Apr. 30, 2015

(54) Dual Planetary System

(71) Applicant: Tihomir SIC, (US)

(72) Inventors: Sic Tihomir, Subotica (RS); Sic Vladimir, Subotica (RS)

(21) Appl. No.: 14/399,584

(22) PCT Filed: Apr. 28, 2013
(86) PCT No.: PCT/IB2013/053356

§ 371 Date: Nov. 7, 2014

(30) Foreign Application Priority Data
May 8, 2012 (RS) RS P20120195

(51) Int. Cl. F16H 1/46; F16H 37/02

(52) U.S. Cl. CPC F16H 1/46; F16H 37/02
USPC 475/182; 475/331

(57) ABSTRACT

An assembly of two independent transmission systems is provided, including a drive system and an output system. The systems are connected by a shaft which transfers a torque from the drive system to a side gear rotating around a fixed gear and forming by this rotating motion a torque on a support. Also, through the shaft, the rotating and orbital motion of the support may be transferred to the drive system thus conditioning the motion of both systems.

### CROSS REFERENCE TO RELATED APPLICATIONS

This application is a national stage application of International Application No. PCT/IB2013/053356, filed on Apr. 28, 2013, which claims the benefit of Serbian Patent Application No. P-2012/0195 filed on May 8, 2012, the entire contents of both applications being incorporated herein by reference.

### BACKGROUND OF THE INVENTION

1. Field of the Invention

The following description relates to revolving motion gearings for change of speed or direction of rotation.

2. Description of Related Art

A design solution of transmission ratios between a revolving motion of a drive shaft and a revolving motion of an output shaft for planetary systems and speed reduction gearings may generally be desired.

Typically, the present design solutions of rotary motion transfer systems (mechanisms) usually include one or more gears of various sizes, known as speed reduction gearings, with the exclusive purpose of increasing torque by reducing the number of revolutions.

Such rotary motion transfer systems may include planetary systems (mechanisms) operating in the same way as speed reduction gears and consisting of several different elements, the basic ones being the sun-wheel, the side gear and the rim.

The above mentioned systems are reliable, but present some shortcomings resulting in operating conditions which strictly require a corresponding gear ratio, which on the other hand directly affects the efficiency rate.

### SUMMARY OF THE INVENTION

In an aspect, a dual planetary system represents a mechanical link between two functionally separated planetary systems. A dual planetary system includes characteristics reflected in a functional partition of the system into a drive system and an output system.

The drive system may include a transfer of torque over a side gear of the drive system to a position where the side gear of the drive system is connected by a direct mechanical link to a side gear of the output system. This link enables a torque that is generated by the two linked elements, the side gear of the drive system and the side gear of the output system, as these elements are rotating within different paths. The side gear of the output system may rotate around a fixed sun-wheel, unlike the side gear of the drive system, which revolves within its own system and around its own axis, at an identical number of revolutions for both systems.

Accordingly, in an aspect, an increased torque is provided that is not conditioned by classic postulates such as gear diameter ratios and rotating speed ratios.

The application is unlimited in all areas of rotating machines.

### BRIEF DESCRIPTION OF DRAWINGS

Other features and advantages of the invention will be apparent from the following description of several embodiments, given as non-limiting examples, with reference to the accompanying drawings in which:

FIG. 1 is a diagram illustrating an example of an overview of a planetary system.

FIG. 2 is a diagram illustrating an example of a cinematic overview of the planetary system.

FIG. 3 is a diagram illustrating an example of an input planetary gear system of the planetary system.

FIG. 4 is a diagram illustrating an example of an output planetary gear system of the planetary system.

FIG. 5 is a diagram illustrating an example of an overview of a belt or chain system with belt or chain transmission.

FIG. 6 is a diagram illustrating an example of a cinematic overview of the belt or chain system.

FIG. 7 is a diagram illustrating an example of a belt or chain transmission drive system of the belt or chain system.

### DETAILED DESCRIPTION

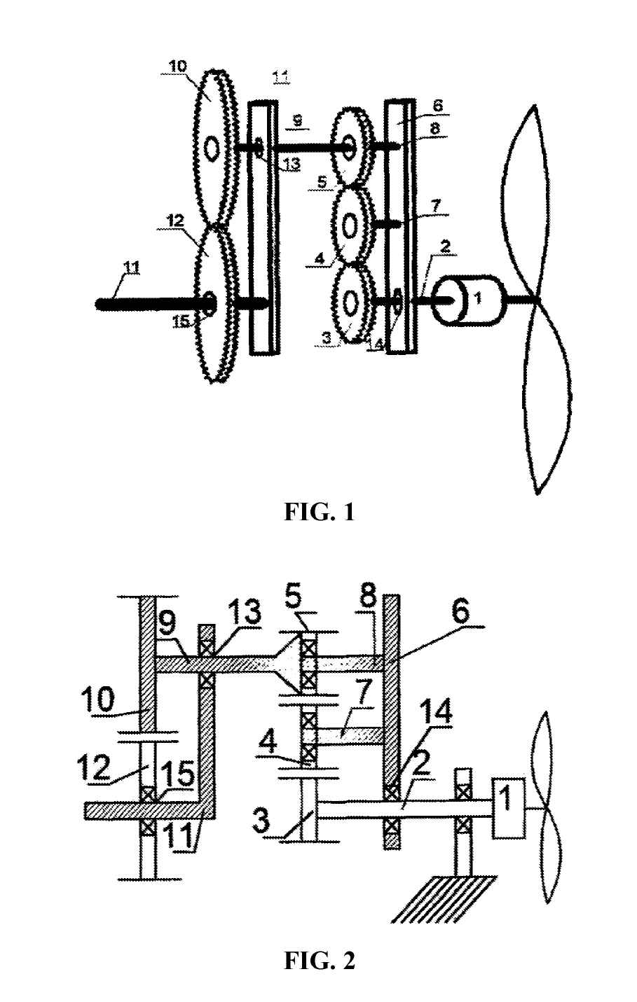

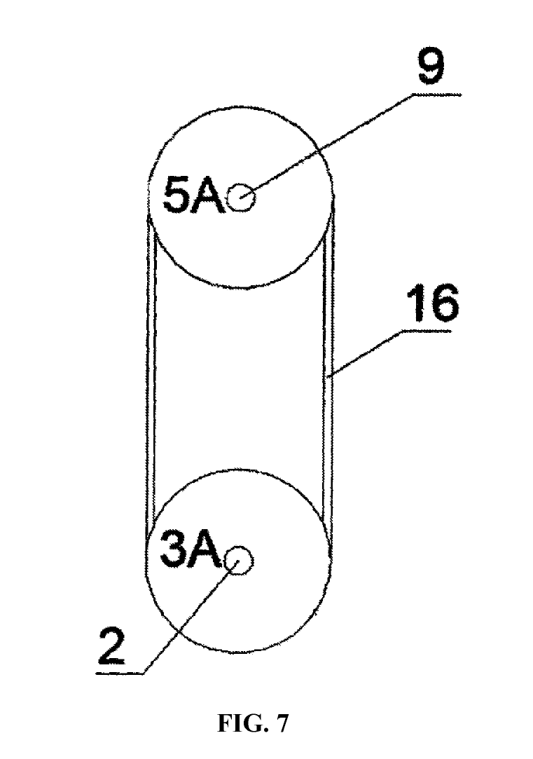

A dual planetary system is distinguished by an unconventional design, as seen in FIGS. 1, 2, 5, 6, and 7, enabling changes in operation mode and development flow during system operation.

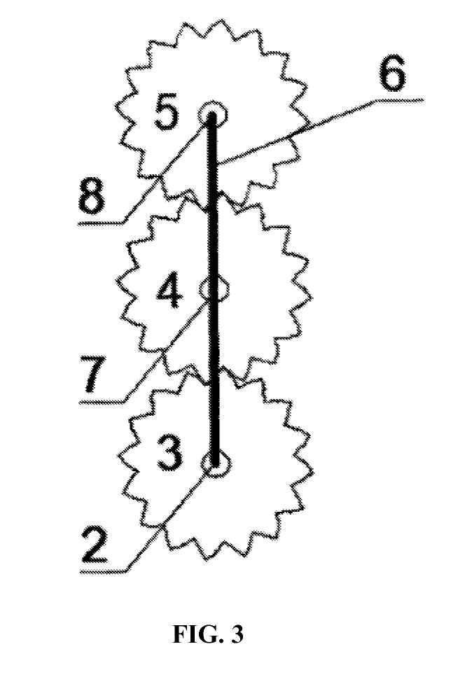

FIGS. 1 and 2 are diagrams illustrating an example of an overview and a cinematic overview of a planetary system.

Referring to the example illustrated in FIGS. 1 and 2, a planetary drive system includes a drive unit 1, connected by a shaft 2 through a bearing 14 of a driving planetary support 6 to a sun-wheel 3. The sun-wheel 3 is intended to transfer a torque T and a motion from the drive unit 1, over to an intermediate side gear 4, and to a side gear 5. The intermediate side gear 4 is, as a free gear, linked over a bearing to the support 6 through a shaft 7. The side gear 5 which is, as a free gear, linked over a bearing to the support 6 through a shaft 8, is at the same time directly mechanically linked by a shaft 9 through a bearing 13 on a support 11 to the side gear 10. Accordingly, in that way, a transfer of the torque T and motion to the output system including the side gear 10 is provided, converting the torque T received from the side gear 5 to a force F.

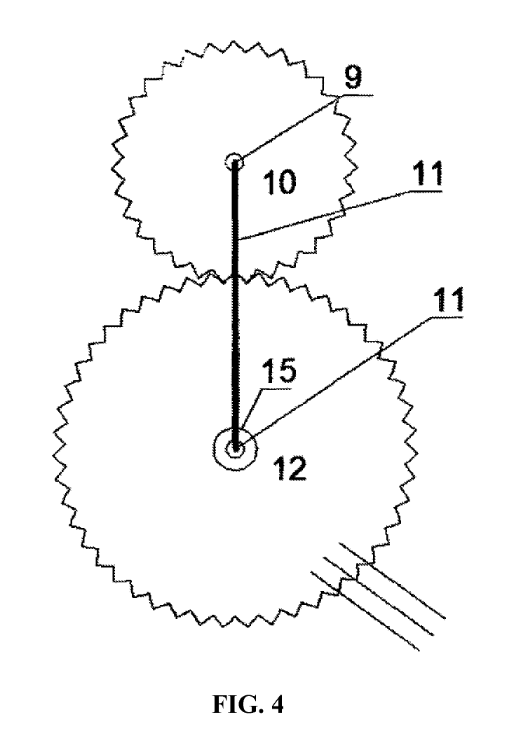

FIG. 3 is a diagram illustrating an example of the input planetary gear system including the sun-wheel 3, the intermediate side gear 4, and the side gear 5 as supported by the support 6, and FIG. 4 is a diagram illustrating an example of an output planetary gear system including the side gear 10 and a sun-wheel 12, described in further detail below, as supported by the support 11.

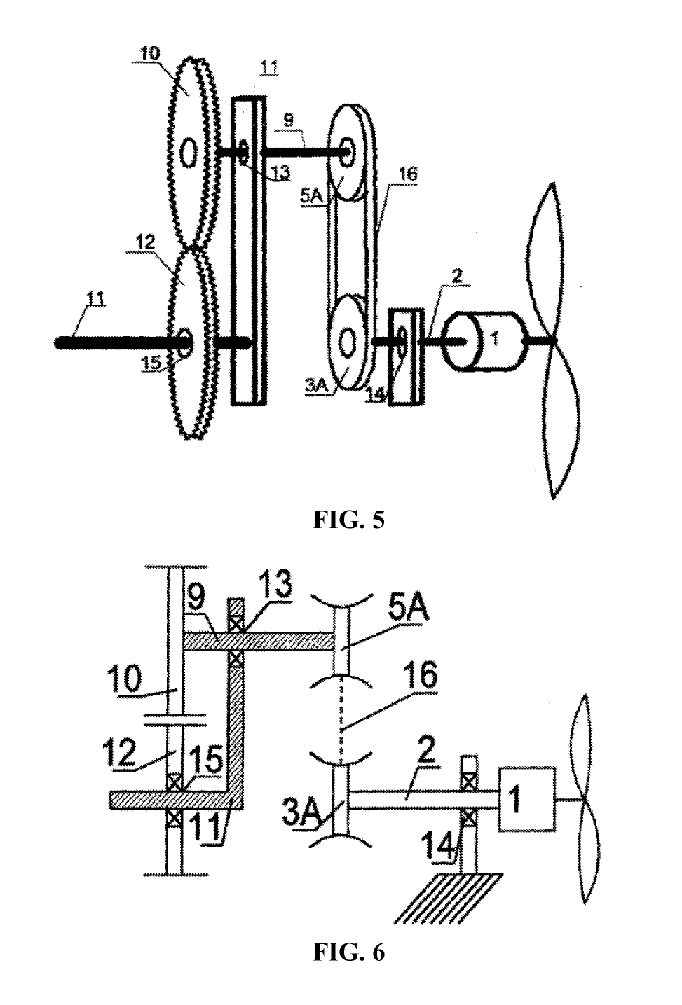

FIGS. 5-7 are diagrams illustrating a belt or chain drive system. Referring to the example illustrated in FIGS. 5-7, a belt or chain drive system includes the drive unit 1, fixedly connected through the shaft 2 to a pulley or chain wheel 3A transferring motion over a transmission belt or chain 15 to a belt or chain wheel 5A. The belt or chain wheel 5A is fixedly connected over the shaft 9 and through the bearing 13 on the support 11, to the side gear 10.

Referring back to the planetary system of FIGS. 1-2 and the belt or chain system of FIGS. 5-7, a force F drives the side gear 10 and forces the side gear 10 to undergo an orbital motion around the sun-wheel 12 because the sun-wheel 12 is fixed and does not rotate. As a consequence of such orbital motion, the side gear 10 inflicts new motions and transfers the orbital motion and the force F through the shaft 9 to the support 11 and through the bearing 13 to the system 3, 4, 5, 6, 7, 8, and still through the shaft 8 to the support 6. Due to the action of the force F, the system 3, 4, 5, 6, 7, 8 gets an orbital motion around the bearing 14, while the sun-gear 3 is rotating in the canter.

Additionally, in the example of belt or chain transmission, the element or wheel 5A transfers the motion through a belt or chain 16 to the element or wheel 3A, during which the element or wheel 5A adopts an orbital motion, while the element or wheel 5A rotates in the canter.

Accordingly, in the examples of the planetary system or the belt or chain system, the orbital motion and the force F of the side gear 10 produce an output torque T on the support 11, linked through a bearing 15 in the fixed sun-gear 12. At the same time, the system 3, 4, 5, 6, 7, 8 and the support 11 run to an identical speed, and the system 5A, 16, 3A also has an identical speed.

1-5. (canceled)

7. A planetary system, comprising:
a drive unit;
a first support and a second support;
a first sun-wheel configured to interact with the drive unit and to rotate in response to a rotation of the drive unit;
a first shaft connected to the drive unit and the first sun-wheel, and extending through a first bearing on the first support;
an intermediate side gear configured to interact with the first sun-wheel and to rotate in response to a rotation of the first sun-wheel;
a second shaft connected to the intermediate side gear and the first support;
a first upper side gear configured to interact with the intermediate side gear and to rotate in response to a rotation of the intermediate side gear;
a second upper side gear configured to interact with the first upper side gear and to rotate in response to a rotation of the first upper side gear;
a third shaft connected to the first upper side gear, the second upper side gear, and the first support, and extending through a second bearing on the second support;
a second sun-wheel that is fixed and does not rotate, and configured to interact with the second upper side gear; and
a fourth shaft extending from the second support through the second sun-wheel,
wherein in response to the rotation of the first upper side gear, the second upper side gear orbits the fixed second sun-wheel and an output torque is applied to the second support.

8. The planetary system of claim 7, wherein the second upper side gear rotates about its own axis and simultaneously orbits around the fixed second sun-wheel thereby forming the output torque that is applied from an axis corresponding to the third shaft.

9. The planetary system of claim 8, wherein the third shaft transfers the orbital and rotating motion of the second upper side gear around the second sun-gear to a drive system comprising the first sun-wheel, the intermediate gear, the first upper side gear, the first support, and the second shaft.

10. The planetary system of claim 9, wherein the third shaft through which the drive system and the second support are linked allow the drive system and an output planetary system, comprising the second support, the second upper side gear, and the second sun-wheel, to have an identical power.

11. The planetary system of claim 9, wherein the output torque is being transferred through the drive system to the third shaft.

12. The planetary system of claim 7, wherein the drive unit is configured to have an identical number of revolutions as the second upper side gear.

13. A belt or chain system, comprising:
a drive unit;
a first support and a second support;
a lower wheel configured to interact with the drive unit and to rotate in response to a rotation of the drive unit;
a first shaft connected to the drive unit and the lower wheel, and extending through a first bearing on the first support;
an upper wheel configured to interact with the lower wheel and to rotate in response to a rotation of the lower wheel;
a belt or chain connecting the upper wheel and the lower wheel;
an upper side gear configured to interact with the upper wheel and to rotate in response to a rotation of the upper wheel;
a second shaft connected to the upper wheel and the upper side gear, and extending through a second bearing on the second support;
a sun-wheel that is fixed and does not rotate, and configured to interact with the upper side gear; and
a third shaft extending from the second support through the sun-wheel,
wherein in response to the rotation of the upper wheel, the upper side gear orbits the fixed sun-wheel and an output torque is applied to the second support.

14. The belt or chain system of claim 13, wherein the upper side gear rotates about its own axis and simultaneously orbits around the fixed sun-wheel thereby forming the output torque that is applied from an axis corresponding to the second shaft.

15. The belt or chain system of claim 14, wherein the second shaft transfers the orbital and rotating motion of the upper side gear around the sun-gear to a drive system comprising the lower wheel, the upper wheel, the belt or chain, and the first support.

16. The belt or chain system of claim 15, wherein the second shaft through which the drive system and the second support are linked allow the drive system and an output system, comprising the second support, the upper side gear, and the sun-wheel, to have an identical power.

17. The belt or chain system of claim 15, wherein the output torque is being transferred through the drive system to the second shaft.

18. The belt or chain system of claim 13, wherein the drive unit is configured to have an identical number of revolutions as the upper side gear.

19. A belt or chain system, comprising:
a drive unit;
a lower wheel connected to the drive unit;
an upper wheel configured to interact with the lower wheel;
a belt or chain connecting the upper wheel and the lower wheel;
an upper side gear connected to the upper wheel;
a shaft connected to the upper wheel and the upper side gear, and extending through a support;
a sun-wheel that is fixed and does not rotate,
wherein the support extends through the sun-wheel and in response to a rotation of the upper wheel, the upper side gear orbits the fixed sun-wheel and an output torque is applied to the support.

20. The belt or chain system of claim 19, wherein the upper side gear rotates about its own axis and simultaneously orbits around the fixed sun-wheel thereby forming the output torque that is applied from an axis extending along the shaft.
